(19) United States
(12) Patent Application Publication
(10) Pub. No.: US 2002/0010070 A1
(43) Pub. Date: Jan. 24, 2002

(54) Zirconia-toughened alumina biocomponent having high resistance to low temperature degradation and method for preparing same

(76) Inventors: Bernard Cales, Evreux (FR); Laurence Blaise, Evreux (FR); Franceline Villermaux, Avignon (FR)

Correspondence Address: Michael L. Goldman, NIXON PEABODY LLP, Clinton Square, P.O. Box 31051, Rochester, NY, 14603, US

(21) Appl. No.: 09/841,274

(22) Filed: Apr. 24, 2001

Related U.S. Application Data
(60) Provisional application No. 60/199,627, filed on Apr. 25, 2000.

(51) Int. Cl. C04B 35/48

(52) U.S. Cl. 501/105

(57) ABSTRACT

A biomedical component comprising zirconia toughened alumina (ZTA), the ZTA comprising 1-69 wt % ZrO₂, the ZrO₂ being partially stabilized with >2.1 mol % yttria or rare earth oxide, and

wherein the component has a surface in which the zirconia fraction of the ZTA has a surface monoclinic content of less than 10 vol. % (preferably no more than 8 vol. %).

### BACKGROUND OF THE INVENTION

Zirconia toughened alumina (ZTA) has already been considered as a material for use in biomedical prosthesis applications.

There are a number of disclosures related to biomedical ZTAs having high zirconia fractions. For example, WO9927871 discloses ZTAs having between about 60-99.9% zirconia. JP 3151978 discloses a ZTA having about 70-90 mol % zirconia partially stabilized by 3 mol % yttria. Affatato, Biomaterials 20 (1999), pp.971-5 discloses a ZTA having 60-80% zirconia.

There are also a number of disclosures related to biomedical ZTAs having high alumina fractions. Certain ZTAs are known which have about 2-40% zirconia, 67-99% alumina, and additions of chromia and strontia. JP 3151978 discloses a ZTA having about 10-30 mol % zirconia, apparently without any stabilizing agent. DD 263703 discloses a ZTA having 3-25% zirconia and a MgO addition. None of these disclosures relate to ZTAs containing yttria as a stabilizing agent.

There are also a number of disclosures related to biomedical ZTAs having a high fraction of alumina, wherein the zirconia in the ZTA is partially stabilized in the tetragonal phase by yttria. Mandrino, Ceramics Subs. Recon. Surg., (1991), pp. 23-30, discloses a preferred ZTA having 20 vol % (about 27 wt %) zirconia partially stabilized by 2 mol % yttria, and suggests its use as a material for a hip joint prosthesis head.

Thompson et al., Biomaterials 1990, 11(9), pp. 505-508, discloses a ZTA having 20 vol % zirconia partially stabilized by a larger amount of yttria (i.e., 3 mol % yttria), and tested this material (along with YTZPs) for 19 months in Ringer's solution at body temperature (37° C.) and found both a 10% loss of strength of the material and also a significant amount of undesirable tetragonal-to-monoclinic phase transformation in the zirconia at the surface of the material. The undesirable tetragonal-to-monoclinic phase transformation in the zirconia at the surface of the material is often called Low Temperature Degradation (“LTD”).

Although YTZP zirconia ceramics are known to have high strength and toughness, they are also known to be susceptible to strength degradation (i.e., LTD) upon exposure to steam in temperatures between 150° C. and 500° C. The origin of this LTD phenomenon is believed to be attributed to a reaction between water and Zr—O—Zr bonds of the ceramic. This reaction causes a transformation of zirconia grains from their desired tetragonal state to their monoclinic state. This transformation is also accompanied by a volume expansion in the transformed grain of about 4%, which causes microcracking in the component and consequent strength degradation.

Thompson et al. concluded that, because of the instability of the tetragonal phase and the deterioration in strength that accompanies the transformation to the monoclinic phase, yttria-stabilized ZTAs and YTZPs of similar composition and grain sizes are unsuitable for bioapplications. Lastly, Thompson suggested that the problem of environment-induced transformation may perhaps be alleviated by the use of a different stabilizing oxide, the addition of a third component to the yttria-stabilized materials, or by producing an ultrafine grain size.

Accordingly, the use of high alumina ZTAs partially stabilized by more than 2.1 mol % yttria in biomedical applications has been discouraged by the art.

Cales et al., J. Biomed. Mat. Res. ,28, 619-24, 1994, disagreed with the conclusions of Thompson et al., and argued that the LTD resistance of YTZPs is a function of many variables not controlled by Thompson, including yttria concentration and uniformity, grain size and flaw population. Cales asserted that Thompson's YTZPs were not state of the art YTZPs, and also provided evidence that state of the art YTZPs are capable of resisting LTD at 37° C. However, the Cales article essentially addresses the LTD issue only for YTZPs, and does not specifically address the LTD issue for high alumina ZTAs partially stabilized by 3 mol % yttria.

### SUMMARY OF THE INVENTION

The present inventors believe that the ZTA material used by Thompson was highly susceptible to LTD. In particular, the strength of Thompson's ZTA was reported to be only 450-500 MPa. As a frame of reference, Treheux, Tribol. Trans. 32(1), 1989, 77-84 reports the strength of a similar composition ZTA to be 700 MPa. This indicates that Thompson's processing procedures may have had led to significant strength-degrading phenomena, including the formation of a significant porosity which would also lower the LTD resistance of the ZTA. Further evidence of the poor LTD resistance of Thompson's ZTA material is found in FIG. 1 of Thompson, wherein the initial monoclinic content of the zirconia at the surface of the ZTA was reported to be between about 10-12%. This large fraction of monoclinic content indicates that the zirconia in Thompson's ZTA had already undergone significant transformation from tetragonal phase to monoclinic phase even before the aging tests were undertaken.

The present inventors believe that high alumina ZTAs having more than 2.1 mol % yttria can be made under carefully controlled conditions such that they possess the LTD resistance necessary for suitable use as biocomponents, without the need for significantly small grain size nor for additional component in addition to yttria stabilized zirconia.

In that Thompson suggests using a different stabilizing material (i.e., one other than yttria) in order to cure the LTD problem in a 80% alumina-20% zirconia-3 mol % yttria material, the direction taken by the present inventors (that of retaining yttria) is somewhat dissuaded by the ZTA art.

Therefore, in accordance with the present invention, there is provided a biomedical component comprising zirconia toughened alumina (ZTA) material, the ZTA material comprising 1-69 wt % ZrO₂, the ZrO₂ being partially stabilized with >2.1 mol % yttria, wherein the component has a surface in which the zirconia fraction of the ZTA has a surface monoclinic content of less than 10 vol. % (such as no more than 8%), preferably no more than 5%, more preferably no more than 2%.

Most preferably, the ZTA material of the present invention has high resistance to LTD. That is, the zirconia fraction of the ZTA has a surface monoclinic content of no more than 40% (preferably no more than 10%, more preferably no more than 5%) after exposure to five cycles of 134° C. steam at 2 bars for 20 hours (i.e. a total exposure time of 100 h).

According to preferred, possibly combined, features of the invention:

zirconia is stabilized in the tetragonal phase by an amount of 2.5 mol. % to 3.5 mol. % of yttria, preferably about 3%,

the amount of zirconia in the component is 10 wt. % to 50 wt. %, preferably from 20% to 30%,

the component has a density of at least 99% of the theoretical density,

the ceramics material has a surface provided with a roughness Ra less than 10 nm,

the ceramics material has a mean grain size less (no more) than 0.5 micron.

The component of the invention can in particular be a hip joint prosthesis head, an insert for an acetabular cup, a tibial plate, a femoral knee component, an intervertebral disc or tooth prosthesis component.

The invention further proposes a method for preparing a biocomponent comprising a zirconia toughnened alumina material having an appropriate low temperature degradation (LTD), preferably comprising the following steps:

optimizing the composition with an yttrium oxide content >2.1 mol % and preferably between 2.9 and 3.2 mol %, more preferably about 3 mol %;

sintering at the lowest temperature to insure at least 95% of theoretical density, for instance in the range 1400-1450° C.;

hot isostatic pressing the already-sintered body in order to reach full density (99% of theoretical density); and

finishing and polishing the working surface (for example the surface in contact with human fluid) in order to reach very low surface roughness. Preferably, the biocomponent has a surface having a surface roughness Ra of no more (less) than 10 nm, more preferably no more (less) than 5 nm.

### DESCRIPTION OF THE FIGURE

Features, characteristics and advantages of the invention will be apparent from the following description, given in an non-limitating way, in reference with enclosed drawings wherein:

FIG. 1 is a diagram showing the ratio of monoclinic phase at 134° C. under 2 bars as a function of time (hours), and

FIG. 2 is a schematic view of a hip joint prosthesis component of the present invention in longitudinal section.

### DETAILED DESCRIPTION OF THE INVENTION

For the purposes of the present invention, the surface monoclinic content of the zirconia is defined as the monoclinic content measured by X-ray diffraction (CuKα, penetration depth of 5 nm) ; surface roughness Ra is measured by optical interferometry; the yttria content of the YTZP is provided in mole percent (mol %) and is calculated based solely upon the molar fraction of yttria to (zirconia+hafnia (impurity)+yttria). The zirconia fraction is considered to include the typical contamination by hafnia (which may be up to 5%).

In one preferred method of making a ZTA ceramics component of the invention, a co-precipitated submicron powder comprising yttria and zirconia is mixed with alumina powder, the powder sizes being 0.45 μm; the mixed powder is cold isostatically pressed at between 50 and 400 MPa and appropriately (if needed) green machined to form a green biomedical component. Once the green component is formed, it is then sintered at between about 1300° C. and 1500° C. for about 1 to 4 hours to achieve a density of at least 95% of the theoretical density; and the sintered piece is hot isostatically pressed (“hipped”) in an inert gas such as argon at between 1300° C. and 1500° C. for between 0.5 and 4 hours to produce a sintered component having a density of at least 99.9% (of the theoretical density) The HIP treatment may induce a more or less significant blackening of the zirconia ceramics because of the loss of oxygen. Recovery of the stoichiometry and to the creamy white color is, if the need arises, obtained through annealing at a temperature from 900° C. to 1200° C. during 2 to 5 hours. The sintered piece is then final machined to the desired shape.

In order to insure that the ZTA material of the present invention is suitably resistant to LTD, the following process steps should preferably be taken:

optimizing the composition with an yttrium oxide content >2.1 mol % and preferably between 2.9 and 3.2 mol %, more preferably about 3 mol %;

sintering at the lowest temperature to insure at least 95% of theoretical density, for instance in the range 1400-1450° C.;

hot isostatic pressing the already-sintered body in order to reach full density (99% of theoretical); and

finishing and polishing the working surface (i.e., the surface in contact with human fluid) in order to reach very low surface roughness. Preferably, the component has a surface having a surface roughness Ra of no more than 10 nm, more preferably no more than 5 nm.

In some preferred embodiments, the ZTA material having high LTD resistance has very low porosity of less than 0.4 vol %, preferably less than 0.1%. Without wishing to be tied to a theory, it is believed that the transformation of the tetragonal grains to monoclinic initially occurs in the vicinity of surface pores. Therefore, eliminating these pores has a tendency to reduce the transformation to monoclinic. Pores in a pressureless sintered YTZP material (which typically possesses at least 1.5 vol % porosity) may be eliminated by hot isostatic pressing that material to essentially full density; it is probably the same in the material of the invention.

In some preferred embodiment, the grain size of the YTZP zirconia within the ZTA is less than 0.5 um. The smaller grains of this preferred embodiment make the YTZP grains even more resistant to LTD phenomena. In more preferred embodiments, however, the grain size of the YTZP is between 0.32 and 0.45 um. In this more preferred range, the grains are small enough to resist LTD but not so small as to eliminate the beneficial transformation capability which provides high strength and toughness.

In general, actual grain size measurements (G) can be converted to average linear intercept measurements (L) by the following formula: G=1.56 L.

Compositionally, the ZTA bioprosthetic component preferably comprises at least about 10 wt % and 50 wt % zirconia (which includes its hafnia content). More preferably, it comprises between 20 and 30 wt % zirconia. Preferably, the ZTA material is stabilized by yttria at a concentration of at least 2.1 mol % (based upon the zirconia+hafnia fraction). More preferably, the ZTA is partially stabilized by yttria at a concentration of between about 2.5 mol % and 3.5 mol % yttria, most preferably between about 2.9 mol % and 3.1 mol % yttria. When yttria is provided in this range, the zirconia fraction in the sintered ZTA body typically comprises at least about 95 vol. % tetragonal phase, more preferably at least 99%. Preferably, the bulk material contains less than 2 wt % oxide impurities which form a glassy phase (not including the hafnia, natural impurity in the zirconia), more preferably less than 1.0 wt %, most preferably less than 0.5 wt %.

Microstructurally, preferably, the YTZP zirconia phase grains have a mean grain size (SEM using ASTM E 112/82) of no more than 0.5 micron (um), preferably between 0.30 and 0.45 um. Also preferably, the alumina grains has a mean grain size (SEM using ASTM E 112/82) of no more than 1 micron (μm), preferably between 0.3 and 0.8 μm. Its density should be between 99 and 100% of theoretical density. Preferably, it should have an open porosity of no more than 0.1%.

In mechanical performance, the bulk of the ZTA bioprosthetic component should preferably have a four point flexural strength of at least about 600 MPa and is typically between 800 and 1000 MPa. In some embodiments, the bulk has an elasticity modulus of no more than 400 GPa, and is typically between 220 and 400 GPa. It typically has a fracture toughness (as per Chantikul) of at least 5 MPa m^{½}, and is likely typically between 5 and 10 MPa m^{½}.

The monoclinic content of a “virgin” surface of the ZTA produced in accordance with the present invention was advantageously found to be only 2% monoclinic. This ZTA material of the present invention can be evaluated for LTD resistance by exposing a polished sample thereof five cycles of 134° C. steam at 2 bars for 20 hours. Tests showed that, when following the invention, the monoclinic content on the polished surface after test is less than 40 vol %, preferably less than 10% and most preferably less than 5 vol %. As these test conditions likely simulate a 100 year exposure in the body at 37° C., the low monoclinic content of the aged material indicates that this ZTA is better than common zirconia for LTD resistance and is suitable for use as a biomedical component.

As an example, a component was prepared with a composition of 25 wt. % of zirconia (stabilized by 3 mol. % of yttria) and 75 wt. % of alumina in the above mentioned grain sizes. The material was cold isostatically pressed under a pressure of 140 MPa, then sintered at about 1500° C. during 3 hours, then annealed under a pressure of more than 100 MPa at about 1400° C. during 2 hours and whitened at about 1000° C. during 2 hours.

The surface roughness was less than 2 nm, and the density was more than 99% of the theoretical density.

The four point flexure strength (ASTM) was 800±131 Mpa for the ZTA; it was of more than 1500 Mpa for the zirconia, and 466±106 Mpa for the alumina.

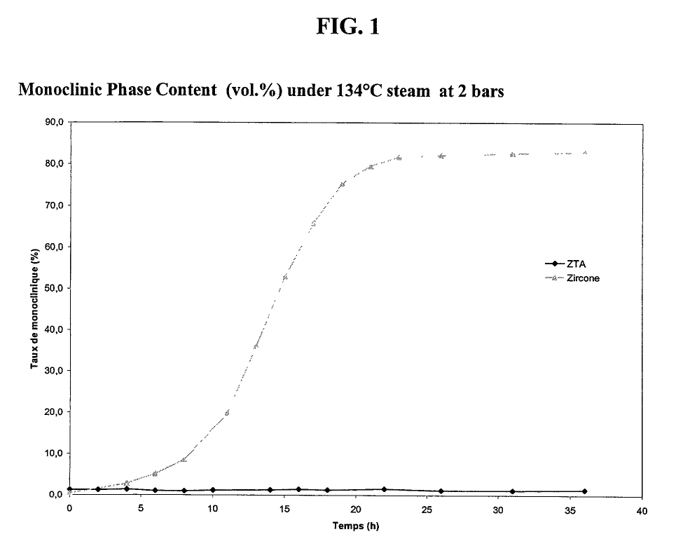

As it can be seen on FIG. 1 the ratio of monoclinic phase (%) at 134° C. under 2 bars remains about 2% for the above mentioned component, whereas it quickly raises between 5 and 15 hours up to about 80% for a classical zirconia.

The ZTA biocomponent of the invention can be used at any site in the body for which alumina, zirconia or other inert ceramics such as ZTA are currently used, including femoral hip joint prosthesis heads, such as the designs shown in U.S. Pat. No. 5,181,929 (“Prats”), U.S. Pat. No. 4,964,869 (Auclair”) and U.S. Pat. No. 5,972,033 (“Drouin”); monolithic acetabular cups; modular acetabular inserts design for taper-fit for reception in metal backings, such as the designs shown in U.S. Pat. No. 5,879,397; U.S. Pat. No. 5,609,647; and U.S. Pat. No. 5,919,236, each of the specifications of which are incorporated herein by reference. It is also preferably used as a biomaterial in tibial plate components, femoral knee components and intervertebral discs or tooth prosthesis component.

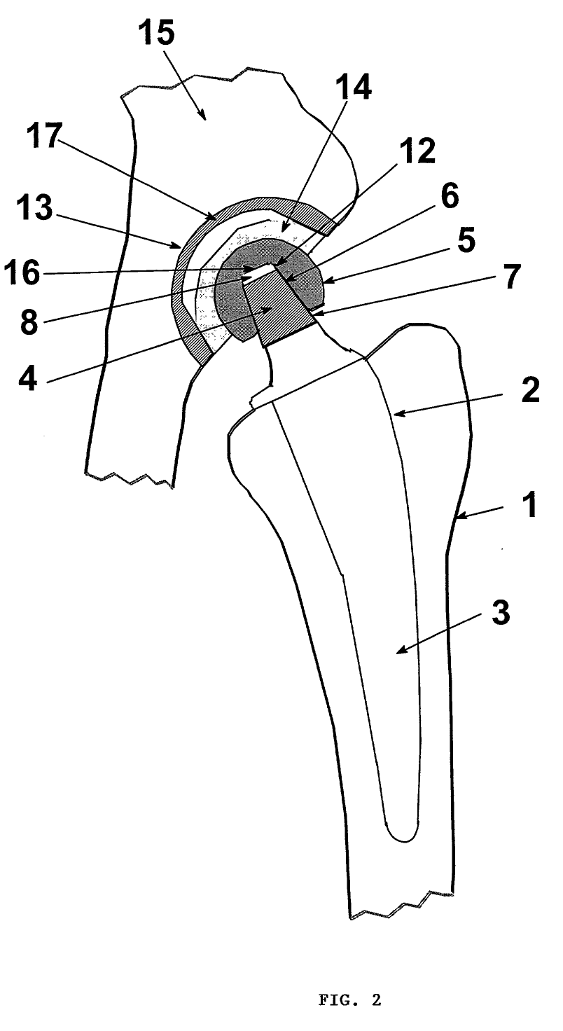

FIG. 2 discloses an example of application of a component according to the invention: within a hip joint prosthesis. The first end 3 of metal trunnion 2 is implanted into femur 1. The second end of the trunnion 2 is shaped to a frustocone 4. The head 5 is an zirconia toughened alumina ZTA material component of the invention, and its recess having about the same taper (conical angle) angle as cone 4 is press fit onto this cone 4. Taper wall 6 of the head 5 defined by the frustoconical recess is in contact over its substantial length with the surface 7 of the frustocone 4. A reserve 8 between the frustocone 4 and the crown 16 is also shown. The junction 12 of the crown 16 of conical recess and the taper wall 6 may be, in some embodiments, a cylinder with connection curvature radii or crown comer. Concurrently, an acetabular cup 13 having a ZTA socket insert 14 which is taper locked in a metal backing 17 is fitted into the pelvic bone 15. Lastly, the ZTA head 5 is positioned in the ZTA socket insert 14 of the acetabular cup 13 to form the hip joint.

Therefore, in accordance with the present invention, there is provided an acetabular cup for receiving a hip joint prosthesis head having a substantially spherical convex outer surface, the cup comprising:

a) a ZTA ceramic component of the invention having a substantially spherical socket surface shaped to rotatably receive the outer spherical convex surface of the hip joint prosthesis head, and

b) a metal backing in which the acetabular ceramic component is received, (preferably, wherein the ceramic component is interference fit either i) directly taper fit within the metal backing, or ii) within a plastic insert, the plastic insert itself being interference fit within the metal backing),

wherein the ZTA comprises 1-69 wt % ZrO₂ , the ZrO₂ being partially stabilized with at least 2.1 mol % yttria or rare earth oxide, and

wherein the component has a surface in which the zirconia fraction of the ZTA has a surface monoclinic content of less than 10% (typically no more than 8%).

Also in accordance with the present invention, there is provided a ZTA ceramic insert for receiving a hip joint prosthesis head having a substantially spherical convex outer surface, the insert comprising:

a) a substantially spherical socket surface shaped to rotatably receive the outer spherical surface of the hip joint prosthesis head, and

b) a properly shaped outer back surface shaped (preferably, frustoconically shaped) to be received in a metal backing,

wherein the ZTA comprises 1-69 wt % ZrO₂, the ZrO₂ being partially stabilized with at least 2.1 mol % yttria or rare earth oxide, and

wherein the component has a surface in which the zirconia fraction of the ZTA has a surface monoclinic content of less than 10% (typically no more than 8%).

Also in accordance with the present invention, there is provided a ZTA ceramic femoral hip joint prosthesis head comprising:

a) a substantially spherical convex outer diameter, and

b) a recess which forms a frustoconical taper wall extending inward from the outer diameter of the head, wherein the recess has a shape suitable for taper fitting upon a frustoconical metal trunnion of a femoral prosthesis to produce contact between the taper wall and the first section of the frustoconical end of the conical trunnion,

wherein the ZTA comprises 1-69 wt % ZrO₂ , the ZrO₂ being partially stabilized with at least 2.1 mol % yttria or rare earth oxide, and

wherein the component has a surface in which the zirconia fraction of the ZTA has a surface monoclinic content of less (typically no more than 8%) than 10%.

Also in accordance with the present invention, there is provided a joint prosthesis comprising:

a) a prosthetic comprising a first ZTA component of the invention having an outer surface, and

b) a second ZTA component of the invention having a surface shaped to receive the outer surface of the first component,

wherein the outer surface of the first component is received on the surface of the second component, and

wherein each ZTA component comprises 1-69 wt % ZrO₂, the ZrO₂ being partially stabilized with at least 2.1 mol % yttria or rare earth oxide, and

wherein the components have a surface in which the zirconia fraction of the ZTA has a surface monoclinic content of less (typically no more than 8%) than 10%.

Also in accordance with the present invention, there is provided a hip joint prosthesis comprising:

a) a substantially spherical ZTA ceramic head comprising zirconia toughened alumina,

b) an acetabular cup having a ZTA ceramic (typically substantially spherical) socket surface shaped to rotatably receive the outer (typically spherical) surface of the ceramic head,

wherein the outer surface of the head is received on the surface of the second component, and

wherein each ZTA component comprises 1-69 wt % ZrO₂, the ZrO₂ being partially stabilized with at least 2.1 mol % yttria or rare earth oxide, and

wherein the components have a surface in which the zirconia fraction of the ZTA has a surface monoclinic content of less (typically no more than 8%) than 10%.

We claim:

1. A biomedical component comprising zirconia toughened alumina ZTA material, the ZTA material comprising 1-69 wt % ZrO₂ , the ZrO₂ being partially stabilized with at least 2.1 mol % yttria, and
wherein the component has a surface in which the zirconia fraction of the ZTA has a surface monoclinic content of less than 10%.

2. The component of claim 1 where the ZrO₂ is partially stabilized in tetragonal phase with between 2.5 and 3.5 mol % yttria.

3. The component of claim 1 or claim 2 wherein the ZTA comprises 10-50 wt % zirconia.

4. The component of claim 3 wherein the ZTA comprises 20-30 wt % zirconia.

5. The component of any one of claims 1 to 4 wherein the surface of the zirconia toughened alumina material has a surface monoclinic content of no more than 5 vol. %.

6. The component of any one of claims 1 to 5 wherein the ZTA component surface has a surface monoclinic content of no more than 40 vol. % after exposure to five cycles of 134° C. steam at 2 bars for 20 hours.

7. The component of claim 6 wherein the surface has a surface monoclinic content of no more than 10% after exposure to five cycles of 134° C. steam at 2 bars for 20 hours.

8. The component of claim 7 wherein the surface has a surface monoclinic content of no more than 5% after exposure to five cycles of 134° C. steam at 2 bars for 20 hours.

9. The component of any one of claims 1 to 8 wherein the ZTA material has a density of at least 99% of theoretical density.

10. The component of any one of claims 1 to 9 wherein the component surface has a surface roughness Ra of no more than 10 nm.

11. The component of any one of claims 1 to 10 wherein the zirconia has a mean grain size of no more than 0.5 μm.

12. The component of any one of claims 1 to 10 wherein the component is a hip joint prosthesis head.

13. The component of any one of claims 1 to 10 wherein the component is an insert for an acetabular cup.

14. The component of any one of claims 1 to 10 wherein the component is a tibial plate.

15. The component of any one of claims 1 to 10 wherein the component is a femoral knee component.

16. The component of any one of claims 1 to 10 wherein the component is an intervertebral disc.

17. The component of any one of claims 1 to 10 wherein the component is a tooth prosthesis component.

18. A method for preparing a biocomponent comprising a zirconia toughened alumina material ceramic having a resistance to low temperature degradation comprising the following process steps:
preparing a powder comprising zirconia and alumina, with a yttria content of more than 2.1 mol. %,
sintering at the lowest temperature to insure at least 95% of theoretical density,
hot isostatic pressing the already-sintered body in order to reach full density (99% of theoretical density); and
finishing and polishing the working surface in order to reach a surface roughness Ra of less 10 nm, more preferably no more than 5 nm.

19. The method of claim 18 wherein the yttria content is between 2.9 wt. % and 3.2 wt. %.

20. The method of claim 18 or claim 19 wherein the sintering is made at a temperature comprised between 1400° C. and 1450° C.
